(19) United States
(12) Patent Application Publication
(10) Pub. No.: US 2007/0089282 A1
(43) Pub. Date: Apr. 26, 2007

(54) Brake spring tool

(76) Inventor: Charles O. Treadway, Danville, IL (US)

Correspondence Address: CHRISTOPHER D. HARRINGTON;SUITE 350, 5300 CORPORATE GROVE SE, GRAND RAPIDS, MI, 49512, US

(21) Appl. No.: 11/256,730

(22) Filed: Oct. 25, 2005

(51) Int. Cl. B23P 19/04

(52) U.S. Cl. 29/227

(57) ABSTRACT

A novel brake spring tool for engaging the brake spring in a braking system, comprises a pair of opposed handle portions and a pair of working ends, where each working end compatibly engages a brake spring end. When the handle portions are transitioned towards each other, the working ends expand the brake spring ends that are engaged thereon, thus allowing the brake spring to be removed from a braking system or to be re-installed onto a braking system without any distortion or damage to the brake spring.

### RELATED APPLICATIONS

Not Applicable

### STATEMENT REGARDING GOVERNMENTALLY FUNDED WORK

Not Applicable

### BACKGROUND OF THE INVENTION

The present invention relates to a tool for working on braking systems. More particularly, the present invention relates to a tool designed to assist in the removal and reinstallation of heavy-duty brake springs.

Brake springs have long been used to provide the tension for the return action for the typical shoe and drum type braking system. Whether the system is based upon a mechanical action or hydraulic, the need for a spring comes from the first action that occurs when the brake is actuated. Typically, the shoes are caused to expand in a drum and the interaction between the face on the shoe and the interior face of the drum will cause the braking action. The expansion of the shoe, however, means that to establish normal driving capability and to alleviate the braking action, it is necessary to cause the shoes to contract and remove the contact of the shoe faces with the drums faces. This is the job of the brake spring, to keep the return bias strong enough to prevent the interaction between the drum and the shoe during non-braking conditions.

Shoe and drum braking systems are still in prevalent use today even with the advent of the disc brake systems. Shoe and drum brake are used on many trucks and in these instances, the brake springs are correspondingly robust. Attempts by mechanics to remove such brake springs without any tool that might give them special leverage, results in a very difficult and time consuming job. The spring tension needed for these applications poses a very unique problem. To overcome the return bias, an extraordinary amount of force is required yet at the same time, it is important to not distort or damage the brake spring in any way that might affect its fit or performance. Many times it is known and has been observed, that mechanics will use combinations of tools that are inappropriately applied to the brake spring, only to cause the spring to be deformed or even break in some cases.

There have been devices made especially for the removal of springs. One of those known in the prior art is taught in U.S. Pat. No. 5,367,755 (Wood) where a tong-like tool is used to grip a specific point on a particular type of brake spring. The usage of this tool is directed towards the Rockwell Q-Series Brake spring which has an in-line shoulder on each end. The tool is able to grip the in-line portion of the Rockwell Q-Series Brake spring on each end and by spreading the tong ends, the spring is expanded and can be removed from an application, or prepared for installation in an application.

Another brake spring tool was disclosed in U.S. Pat. No. 5,140,734 (Taggart) where a plier-like tool has one working end that fits into a feature on the drum body and the other end hooks a spring end for installation and removal of the spring. This invention is directed towards a specific type of brake spring application and only acts on one end of the subject brake spring. A similar approach is taken in U.S. Pat. No. 6,698,074 (Kang) where a brake wrench is made to specifically address the type of spring and drum relationship described in U.S. Pat. No. 5,140,734 above.

Another version of a brake spring tool is shown in U.S. Pat. No. 5,423,113(Jezowski) where a tong-like tool is sued to remove the brake springs found on air brakes. This is an application for a brake spring of the type of interest with respect to the present invention, since it involves a brake spring that is extremely robust and therefore difficult to remove without using brute force or the finesses of some specific leverage. In the case of U.S. Pat. No. 5,423,113 the leverage is obtained by the usage of the long-handled tongs which is beneficial when the working ends that engage the brake spring are caused to expand. The working ends of the tool engage the brake spring ends using angled slots that are cut into the tool. These slots grasp the brake spring ends in chord-like fashion which results in an affirmative grip but one that applies the force in an unbalanced and awkward manner. This approach will cause distortion of the brake spring as it is expanded, leading to problems when trying to reuse the same brake spring, and even worse, possibly causing damage to the brake spring integrity possibly leading to unnecessary brake spring failure.

Notwithstanding the advance of the prior art, there still remains a longstanding problem when using tools for removing and re-installing brake springs. The need is still felt for a tool that can adequately generate the leverage and thereby the force necessary to easily expand the more robust brake springs, and to do so without distorting the brake spring architecture or otherwise damaging the brake spring. The brake spring tool of the present invention solves this longstanding need with a device that is simple to use and which has superior characteristics in managing the brake spring expansion. The attributes and benefits of the present invention will be discussed in more detail below.

### SUMMARY OF THE INVENTION

A new brake spring tool for the removal and the re-installation of a brake spring in a shoe-and-drum type braking system comprises a handle portion of sufficient length to generate leverage to expand a brake spring, and a pair of working ends that engage a brake spring, and a pivot point for transferring the leverage generated by the handle portion to the working ends. The working ends of the present invention further include at least one spring engager that compatibly engages a brake spring end and exerts a balanced force for the expansion of the brake spring. In one embodiment of the present invention, the other working end is provided with an end that engages a brake spring coil and similarly transmits a balanced force to the brake spring coil for the expansion of the brake spring.

In the preferred embodiment of the present invention, both working ends of the brake spring tool engage the brake spring ends and each exerts a balanced force for the expansion of the brake spring.

These and other attributes and features of the present invention will be discussed in more detail below.

### BRIEF DESCRIPTION OF THE DRAWINGS

FIG. 1 is a front elevational view of the brake spring tool of the present invention, showing the embodiment that has one working end with a spring engager and the other working end that is for the engagement of the brake spring coils.

FIG. 2 is a partial front elevational view of the brake spring tool as shown in FIG. 1, where the brake spring tool is engaging a brake spring.

FIG. 3 is a partial side elevational view of the brake spring tool of FIG. 1 as taken at Section 3-3.

FIG. 4 is a partial side elevational view of the brake spring tool of FIG. 1 as taken at Section 4-4.

FIG. 5 is a cross sectional view of the brake spring tool of FIG. 1 as taken at Section 5-5.

FIG. 6 is a cross sectional view of the brake spring tool of FIG. 1 as taken at Section 6-6.

FIG. 7 is a cross sectional view of the brake spring tool of FIG. 1 as taken at Section 7-7.

FIG. 8 is a partial front elevational view of another embodiment of the present invention, showing working ends that each employ spring engagers and shown as engaging a brake spring.

### DETAILED DESCRIPTION OF THE PREFERRED EMBODIMENTS

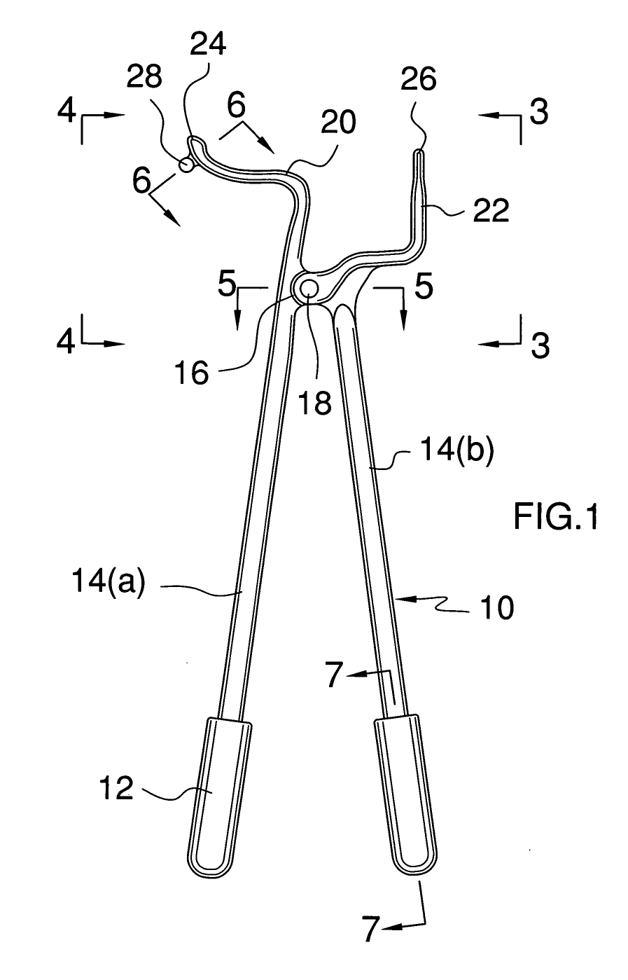

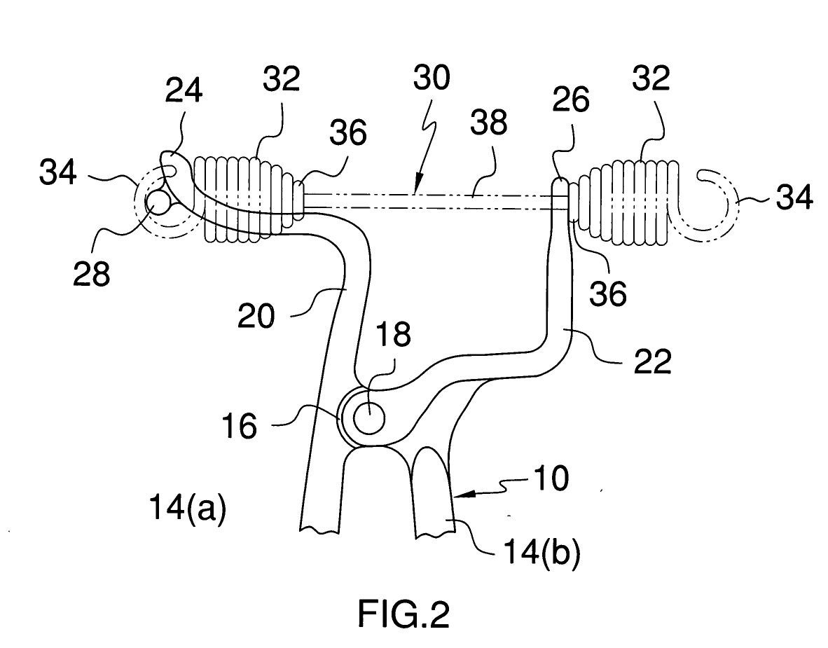

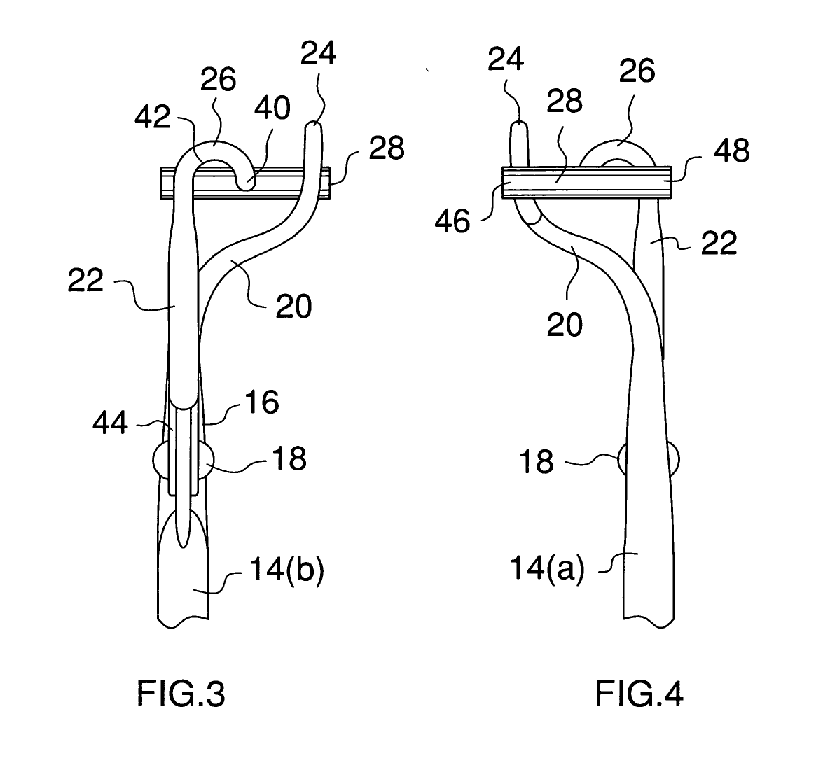

A new brake spring tool 10 in accordance with the present invention is shown in FIG. 1 and includes handle grips 12, handles 14(a) and 14(b), the hinge 16, the hinge pin 18, the set arm 20 with set arm end 24, and the adjustment arm 22 with the adjustment arm end 26. The set arm 20 further includes the spring engager 28. In FIG. 2, the brake spring tool 10 is shown engaging an S-Cam spring 30 which includes the spring coils 32, the spring ends 34, the coil ends 36 and the spring shaft 38. In FIGS. 3 and 4, the brake spring tool 10 is shown with the adjustment arm tip 40, the adjustment arm radius 42 and the yoke 44. The set arm 20 includes the spring engager base 46 and the spring engager end 48.

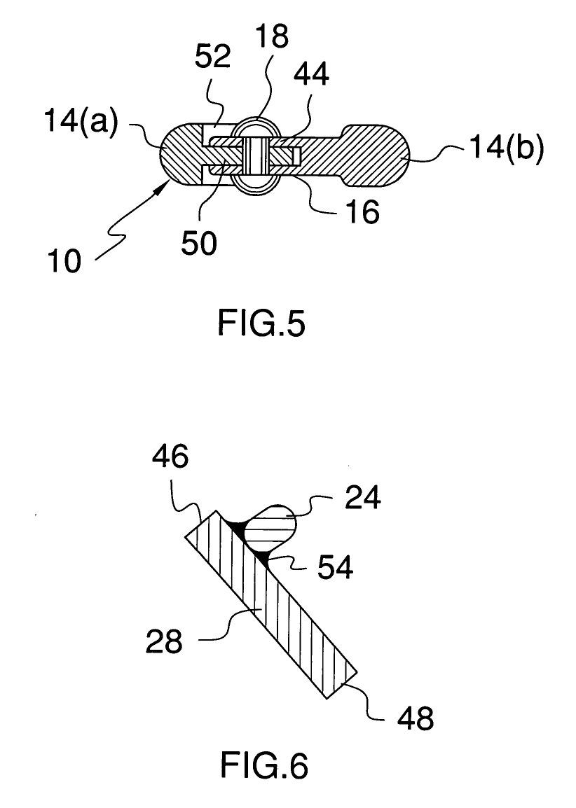

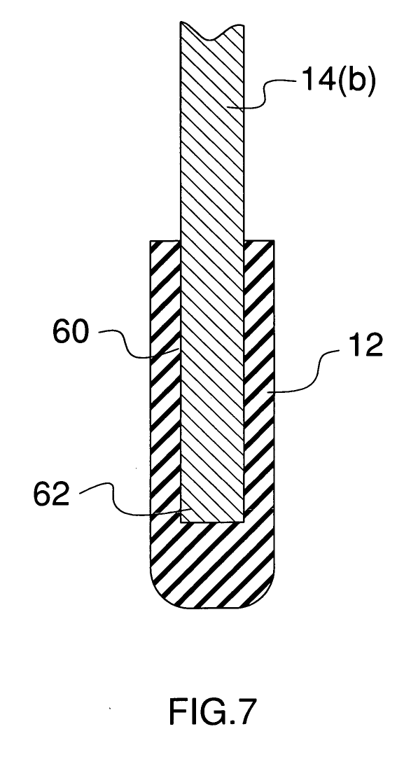

In FIGS. 5 and 6, components of the brake spring tool 10 are shown in closer detail, including the flange 50, the set arm radius 52 and the weld 54. In FIG. 7, the handle grip 12 is shown with the handle grip well 60 and the handle 14(b) is shown with handle end 62.

In use, the brake spring tool 10 is designed to handle a specific type of spring, one known as an S-Cam spring 30 that finds use in heavy duty applications such as in truck brakes. The S-Cam spring 30 is used on the shoe and drum type of brake design, and the S-Cam spring 30 is typically a robust spring that requires significant force to cause it to expand. With respect to the present embodiment, the brake spring tool 10 utilizes the handle portion, comprised of the handle grips 12, the handles 14(a) and 14(b), as connected to a pivot portion which is comprised of the hinge 16 and the hinge pin 18, and then finally working ends which are comprised of the set arm 20 and the adjustment arm 22. Each working end is integrally combined with a corresponding handle and the hinge 16 connotes the difference between the two, and the pair of such combination of working end and handle pivots about the hinge 16. In the present embodiment, the set arm 20 and the adjustment arm 22 have a spring engager 28 and the adjustment arm tip 40 as the components that actually contact the brake spring 20.

The working ends are positioned to engage the brake spring 20, the set arm engaging the spring end 34 and the adjustment arm engaging the coil end 36. In particular, the spring engager 28 rests within the curvature of the spring end 34 as depicted in the drawings with the radius of the spring engager 28 engaging the inner radius 35 of the spring end 34. This allows the spring engager 28 to express any force applied to the spring end in an evenly balanced fashion without the potential for bending or distorting the structure of the brake spring 30. On the other working end, the adjustment arm 22 has the adjustment arm tip 40 that has a “hook” shape that compatibly receives the spring shaft 38 and allows the adjustment arm tip 40 to contact the coil end 36. Expansion pressure exerted on the adjustment arm 22 is expressed at the adjustment arm tip 40. This is then transmitted to the coil end 36 and given the shape of the adjustment arm tip 40 which uniformly contacts the surface of the coil end 36 such that the expansion force is distributed evenly across the coil end without distortion of the brake spring 30.

The brake spring tool of the present embodiment is useful both when the subject brake spring is to be removed from the braking system, and also when it is to be re-installed. If the same brake spring is to be re-used, it is critically important for the integrity of the braking function that the brake spring is not damaged or altered. The present invention ensures this by distributing the expansion force evenly across the brake spring 30. For instance, during a removal procedure, the set arm and the adjustment arm each engage the brake spring in a way that minimizes the potential for distortion of the brake spring and which distributes the loads being placed on the brake spring more evenly than has been accomplished in the prior art. With reference to FIG. 2, the set arm engages the brake spring coil with the spring engager while at the same time, the adjustment arm tip engages the inward face of the coil end. The handles of the brake spring tool are now compressible in the direction that expands that distance between the set arm and the adjustment arm, resulting in the expansion of the brake spring. The movement of the handles relative to the set arm and the adjustment arm is governed by the hinge which is placed closer to the set arm and adjustment arm ends, rather then the handle ends, resulting in handles that are longer. The length of the handles results in significant mechanical leverage in overcoming the tension of the brake spring and allows the removal and re-installation process to be undertaken with minimal effort on the part of the mechanic.

The brake spring tool of the present invention can be fabricated from two pieces of formed metal, one for the handle/set arm portion and one for the handle/adjustment arm portion. The two are interconnected at the hinge by means of the hinge pin which allows rotational movement. The selection of the method for fabricating the brake spring tool and the type of metal chosen are matters left for one skilled in the art and do not specifically relate to the present invention beyond this.

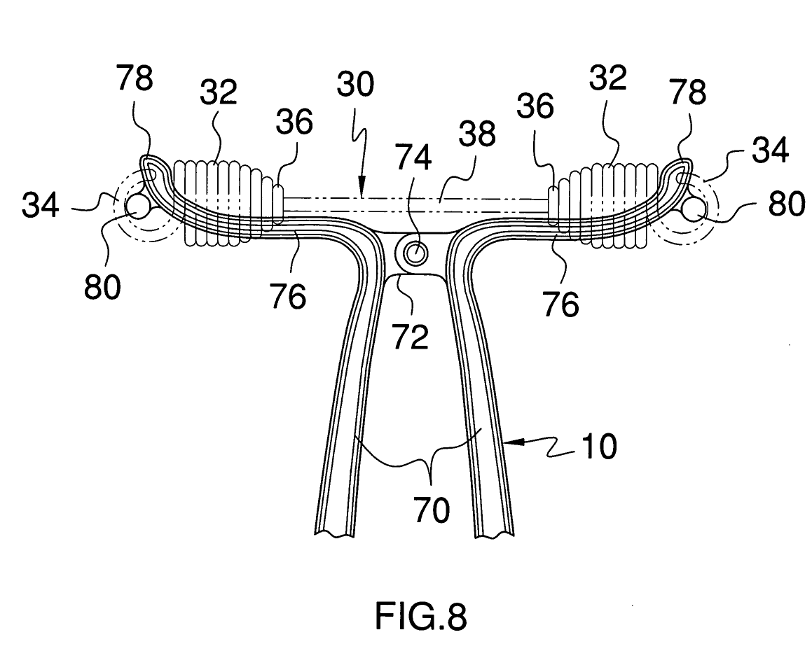

Turning now to FIG. 8, a second embodiment of the present invention is shown that includes the handles 70, the hinge 72, the hinge pin 74, and the arms 76. The arms 76 further include the arm ends 78 and the spring engagers 80. The brake spring 30 is of the same type and construction as the brake spring discussed above.

In this version of the invention, the brake spring tool is symmetrical with each handle 70 and arm 76 being the mirror image of the opposing feature resulting in left-handed and right-handed versions of the handles. This embodiment allows for a greater degree of expansion given the distance between arm ends 78 and the hinge 72 as compared to the prior embodiment where the adjustment arm tip was closer to the hinge. The usage is substantially the same as described above, with the arm ends, specifically the spring engagers, contacting and engaging the brake spring coils. Obviously in this embodiment both handles have spring engagers at the point of contact so the functional aspects of the engagement and expansion relate to the way the spring engagers meet and work on the brake spring coils. The effect is the same, where the radiussed portion of the spring coil meets the inner radius of the spring engager, maximizing the contact area and spreading the working loads accordingly. The alignment of the force that is applied to the spring engagers to cause the expansion of the brake spring is substantially along the longitudinal axis of the brake spring which is centered at or about the shaft 38. This alignment allows the brake spring to be expanded with minimal distortion, and therefore with less potential for damage to the brake spring. Unlike the prior art devices, the alignment of the expansion force and the use of the radiussed spring engagers in the present invention will not cause the spring ends 34 to be twisted into abnormal positions as would be the case where they are constrained or held by a clamp or by a jig. Any twisting of the brake spring is to be avoided since this introduces unintended weakness into the brake spring and it also can possible cause inelastic deformations in the configurations of the brake spring in the spring coils, the shaft or in the spring ends. Any change in the configuration of the brake spring will render it non-conforming as to its use in the braking system, which could have dangerous consequences as far as the operation of the braking system is concerned.

The fabrication of either embodiment illustrated herein is left to one skilled in the art with respect to the techniques for the selection of the type of metal to be used and how it is to be formed, so long as the parameters and objectives set forth above are kept in mind. It is believed that a cast steel would be an acceptable selection for the first embodiment owing to the configuration required, whereas the second embodiment may be made from a cast steel or from steel that is formed and then hardened. Other metals may be contemplated for use with either embodiment including aluminum or titanium, however the selection of the metal is likely to be influenced by economic parameters insofar as the resultant cost that each such selection might reflect.

The teachings with respect to brake springs may not be limited to S-cam type of braking system but would apply wherever a brake spring of the type and configuration shown herein would be used.

I claim:

1. A brake spring tool for the removal and reinstallation of brake springs, the brake spring tool comprising:
A pair of opposed handle portions;
A pivot point; and,
A pair of working end portions where said working end portions compatibly engage a brake spring and where each working end portion integrally extends from a corresponding handle portion with the pivot point located at the point of difference between each of such handle portion and working end and each combination of working end and handle portion pivots at the pivot point and are interconnected at the pivot point, and upon the application of compressible tension on the handle portions, the distance between the working end portions increases and when the working end portions engage a brake spring causes the brake spring to expand without distorting the brake spring and allowing it to be removed or to be re-installed in a brake spring application.

2. The brake spring tool of claim 1, where the working end portions comprise a set arm and an adjustment arm.

3. The brake spring tool of claim 1, where one working end portion is right-handed and the other working end portion is left-handed, and each further includes a spring engager for engaging the brake spring.

4. The brake spring tool of claim 3, where each spring engager is radiussed and compatibly engages the inner radius of a brake spring end, and when the compressible tension is applied to the handle portion, the distance between each spring engager and each brake spring end increases.

5. The brake spring tool of claim 2, where the set arm further includes a spring engager for engaging the end of a brake spring, and where the adjustment arm further includes an adjustment arm tip for engaging the coil end of a brake spring, and where upon the application of the compressible tension to the handle portions, the distance between the spring engager and the adjustment arm tip increases.

6. A brake spring tool for the removal and reinstallation of brake springs, the brake spring tool comprising:
A pair of opposed handle portions, comprising a right-handed handle and a left-handed handle;
A pivot point, comprising a hinge;
A pair of working end portions where one working end portion is right-handed and the other working end portion is left-handed, and where each of said working end portions compatibly engage a brake spring and where each working end portion integrally extends from a corresponding handle portion with the pivot point located at the point of difference between each of such handle portion and working end and each combination of working end and handle portion pivots at the pivot point and are interconnected at the hinge, and upon the application of compressible tension on the handle portions, the distance between the working end portions increases and when the working end portions engage a brake spring causes the brake spring to expand without distorting the brake spring and allowing it to be removed or to be re-installed in a brake spring application.

7. The brake spring tool of claim 6, where each working further includes a spring engager for engaging the brake spring.

8. The brake spring tool of claim 7, where each spring engager is radiussed and compatibly engages the inner radius of a brake spring end, and when the compressible tension is applied to the handle portion, the distance between each spring engager and each brake spring end increases.

9. A brake spring tool for the removal and reinstallation of brake springs, the brake spring tool comprising:
A pair of opposed handle portions;
A pair of working ends where each working end integrally extends from a corresponding handle portion; and,
A hinge interconnecting each of said combination of working ends and handle portions where said working end portions compatibly engage a brake spring and upon the movement of the handle portions in a direction decreasing the distance between each the distance between the working end portions increases and when the working end portions engage a brake spring causes the brake spring to expand without distorting the brake spring and allowing it to be removed or to be re-installed in a brake spring application.

10. The brake spring tool of claim 9, where the working end portions comprise a set arm and an adjustment arm.

11. The brake spring tool of claim 10, where the set arm further includes a spring engager for engaging the end of a brake spring, and where the adjustment arm further includes an adjustment arm tip for engaging the coil end of a brake spring, and where upon the decrease in the distance between the handle portions the distance between the spring engager and the adjustment arm tip increases.

12. The brake spring tool of claim 11, where the spring engager radius engages the inner radius of the spring end.

13. The brake spring tool of claim 9, where one working end portion is right-handed and the other working end portion is left-handed, and each further includes a spring engager for engaging the brake spring.

14. The brake spring tool of claim 13, where each spring engager is radiussed and compatibly engages the inner radius of a brake spring end.
